(19) United States
(12) Patent Application Publication
(10) Pub. No.: US 2026/0256168 A1
(43) Pub. Date: Sep. 3, 2026

(54) COMPOSITIONS

(71) Applicant: GIVAUDAN SA, VERNIER (CH)

(72) Inventors: Krystof MICHALSKY, Avignon (FR); Lise LAURENCON, Garlin (FR); Susanne Katharina STEGHÖFER, Dortmund (DE)

(21) Appl. No.: 19/159,614

(22) PCT Filed: Feb. 26, 2024
(86) PCT No.: PCT/EP2024/054792

§ 371 Date: Aug. 26, 2025

(30) Foreign Application Priority Data
Feb. 27, 2023 (GB) 2302791.5

(51) Int. Cl. A23L 2/56; A23B 70/10; A23L 27/12; A23L 27/29

(52) U.S. Cl. CPC A23L 2/56; A23B 70/10; A23L 27/13; A23L 27/29

(57) ABSTRACT

The present invention is related to a method for preparing a storage-stable flavored composition, said method comprising: (a) providing a flavored composition comprising a synthetic and/or natural flavor as a flavoring agent; and (b) adding a lemon balm extract comprising rosmarinic acid to the flavored composition from step (a) to obtain a storage-stable, flavored composition, as well as the storage stable flavored compositions so obtained.

### TECHNICAL FIELD

The present disclosure relates to a method for preparing a storage-stable, flavored composition, said method comprising:
(a) providing a citrus-flavored composition comprising a synthetic and/or natural flavor as a flavoring agent; and
(b) adding a lemon balm extract comprising rosmarinic acid to the citrus-flavored composition from step (a) to obtain a storage-stable, citrus-flavored composition.

### BACKGROUND

Colour and flavour is an important attribute of finished consumable food and beverage products. It is important to maintain the recognized colour and flavour of a consumable throughout its shelf-life. Consumers would be less inclined to purchase or use a consumable that did not exhibit its customary and recognized colours and flavours, believing that there may be a quality or spoilage issue associated with such consumable. Citrus flavours in beverages are demanded by the consumers, however, some of them may develop off notes during storage.

### FIGURES

FIG. 1—Sensory profiling results with and without LB for Lemon flavor protection in beverages.

### SUMMARY

In a first illustrative aspect, provided is a method for preparing a storage-stable flavored composition, said method comprising:
(a) providing a flavored composition comprising a synthetic and/or natural flavor as a flavoring agent; and
(b) adding a lemon balm extract comprising rosmarinic acid to the flavored composition from step (a) to obtain a storage-stable, flavored composition. According to a second illustrative aspect, provided is a method for increasing the shelf life, reducing oxidation and/or reducing off notes of a flavored composition during storage, said method comprising:
(a) providing a citrus-flavored composition comprising a synthetic and/or natural flavor as a flavoring agent; and
(b) adding a lemon balm extract comprising rosmarinic acid to the flavored composition from step (a).

According to another illustrative aspect, provided is a method for preparing a storage-stable, citrus-flavored composition, said method comprising:
(a) providing a citrus-flavored composition comprising a synthetic and/or natural flavor as a flavoring agent; and
(b) adding a lemon balm extract comprising rosmarinic acid to the citrus-flavored composition from step (a) to obtain a storage-stable, citrus-flavored composition.

According to another illustrative aspect, provided is a method for increasing the shelf life, reducing oxidation and/or reducing off notes of a citrus-flavored composition during storage, said method comprising:
(a) providing a citrus-flavored composition comprising a synthetic and/or natural flavor as a flavoring agent; and
(b) adding a lemon balm extract comprising rosmarinic acid to the flavored composition from step (a).

According to another illustrative aspect, provided is a composition obtained according to the methods of the invention.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

The terms “comprises,” “comprising,” “has,” “having,” “includes,” “including,” “contains,” “containing,” or any other variation are open-ended and are intended to cover a non-exclusive inclusion of elements, such that an article, apparatus, compound, composition, combination, method, or process that “comprises,” “has,” or “includes,” or “contains” a recited list of elements does not include only those elements but may include other elements not expressly listed, recited or written in the specification or claims. An element or feature proceeded by the language “comprises . . . a,” “contains . . . a,” “has . . . a,” or “includes . . . a” does not, without more constraints, preclude the existence or inclusion of additional elements or features in the article, apparatus, compound, composition, combination, method, or process that comprises, contains, has, or includes the element or feature.

The terms “a” and “an” are defined as one or more unless expressly stated otherwise or constrained by other language herein. An element or feature proceeded by “a” or “an” may be interpreted as one of the recited element or feature, or more than one of the element or feature.

The terms “about,” “approximately,” “essentially,” “substantially,” any other version thereof, or any other similar relative term, or similar term of approximation, are defined as being close to as understood by one having ordinary skill in the art. By way of non-limiting, illustrative embodiments, these terms are defined to be within 20% of a recited value, or defined to be within 10% of a recited value, or defined to be within 5% of a recited value, or defined to be within 4% of a recited value, or defined to be within 3% of a recited value, or defined to be within 2% of a recited value, or defined to be within 1% of a recited value, or defined to be within 0.5% of a recited value, or defined to be within 0.25% of a recited value, or defined to be within 0.1% of a recited value.

It should be understood that when an amount in weight percent is described in the present disclosure, it is intended that any and every amount within the range, including the end points, is to be considered as having been expressly disclosed. For example, the disclosure of “a range of from about 1 to about 10” is to be read as indicating each and every possible number along the continuum between about 1 and about 10. It is to be understood that the inventors appreciate and understand that any and all data points within the range are to be considered to have been specified, and that the inventors have possession of the entire range and all points within the range.

When a concentration is expressed as “ppm”, the concentration is parts per million by weight based on the total weight of the consumable. It should be understood that when a range of values is described in the present disclosure, it is intended that any and every value within the range, including the end points, is to be considered as having been disclosed. For example, “a range of from 1 ppm to 1000 ppm” of a component of the composition is to be read as indicating each and every possible number along the continuum between 1 and 1000. It is to be understood that the inventors appreciate and understand that any and all values within the range are to be considered to have been specified, and that the inventors have possession of the entire range and all the values within the range.

For the avoidance of doubt, preferences, options, particular features and the like indicated for a given aspect, feature or parameter of the invention should, unless the context indicates otherwise, be regarded as having been disclosed in combination with any and all other preferences, options, particular features and the like as indicated for the same or other aspects, features and parameters of the invention.

The experiments included in the present text clearly demonstrate that the use of lemon balm extract impairs the development of undesirable off notes (oxidized citral, oxidized terpenes etc.) while the typical taste of the citrus flavour are preserved, even at very long storage times (more than 6, 9 or even 12 weeks) at high temperatures (see example 4).

The present invention related to a method for preparing a storage-stable flavored composition, said method comprising:
(a) providing a flavored composition comprising a synthetic and/or natural flavor as a flavoring agent; and
(b) adding a lemon balm extract comprising rosmarinic acid to the flavored composition from step (a) to obtain a storage-stable, flavored composition.

The present invention is related to a method for increasing the shelf life, reducing oxidation and/or reducing off notes of a flavored composition during storage, said method comprising:
(a) providing a flavored composition comprising a synthetic and/or natural flavor as a flavoring agent; and
(b) adding a lemon balm extract comprising rosmarinic acid to the flavored composition from step (a).

Melissa officinalis (lemon balm) is a plant from the Lamiaceae family. Lemon balm and Melissa officinalis are interchangeable in the present application.

In a preferred embodiment, the extract of Melissa officinalis is obtained from aerial parts. In certain embodiments, the lemon balm extract is extracted using water and/or an alcoholic solvent. The term “alcoholic solvent” includes, without limitation, ethanol, methanol, heptane, and hexane

In a preferred embodiment of the composition of the invention the Melissa officinalis aerial parts extraction is carried out with water.

Water extractions are well-known in the art and their application is part of the general knowledge of the expert. In a preferred embodiment of the composition of the invention the extraction of the Melissa officinalis aerial parts is carried out at a temperature of about 80° C. to about 100° C., preferably 90° C., for about 1 hour to about 3 hours, preferably about 1.5 hours, by percolation.

In a preferred embodiment of the composition of the invention the extract of Melissa officinalis aerial parts obtained is further filtered and concentrated, preferably concentrated by membrane filtration.

Once the concentration step has been carried out, the extract may be purified on polymeric adsorbent resin and the purified extract is spray dried on maltodextrin or formulated on ethanol or propylen glycol.

The term “aerial parts” as used herein refers to, but is not limited to, the shoots, leaves, stems, flowers, fruits and seeds, preferably the leaves or seeds of Melissa officinalis.

In a preferred embodiment of the composition of the invention the extract of Melissa officinalis aerial parts is obtained by an extraction with ethanol and activated carbon.

In another preferred embodiment the of the composition of the invention the extract of Melissa officinalis aerial parts is obtained with ethanol and activated carbon wherein the ethanol is used at a concentration of about 70% v/v solvent to water and the activated carbon is used at a concentration of about 1% w/v to about 15% w/V, preferably about 3% w/v, about 4% w/v, about 5% w/v, about 6% w/v, about 7% w/v, about 8% w/v, about 10% w/V.

In certain embodiments, the lemon balm extract may be considered as a flavoring.

Rosmarinic acid is an ester formed via the esterification of caffeic acid with 3,4-dihydroxyphenyl lactic acid. Rosmarinic acid is defined in the entry of the database CAS Registry with the number 20283-92-5 as well as structurally by formula (vii)

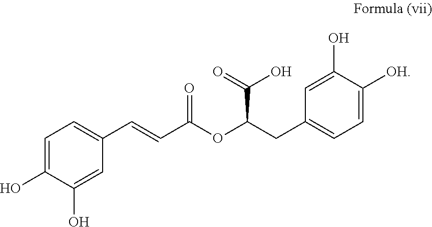 [SMILES: O=C(/C=C/c1ccc(O)c(O)c1)O[C@H](Cc1ccc(O)c(O)c1)C(=O)O]

The Melissa officinalis extract used in the present invention may comprise other components like one or more of Isomelitric Acid, Syringic Acid, Caffeoyl tartaric acid, Caffeic acid, yunnaneic acid derivative, Sagerinic acid/caffeic acid tetramer, Luteolin-7-glucuronide, Salvianolic acid B, pulmitric acid B/sagecoumarin, Trihydroxycinnamic acid derivative.

In certain embodiments, the Melissa officinalis extract used in the present invention may comprise at least 1% w/w rosmarinic acid, such as at least 2%, 3%, 4%, 5%, 6%, 7%, 8%, 9%, 10%, 15%, 20%, 25%, 30%, 35%, 40%, 50%, 60% or at least 70% w/w of rosmarinic acid.

In certain embodiments, the Melissa officinalis extract used in the present invention may comprise at least 1% w/w Syringic Acid, such as at least 2%, 3%, 4%, 5%, 6%, 7%, 8%, 9%, 10%, 15%, 20%, 25%, 30%, 35%, 40%, 50%, 60% or at least 70% w/w of Syringic Acid.

In certain embodiments, the Melissa officinalis extract used in the present invention may comprise at least 1% w/w Isomelitric Acid, such as at least 2%, 3%, 4%, 5%, 6%, 7%, 8%, 9%, 10%, 15%, 20%, 25%, 30%, 35%, 40%, 50%, 60% or at least 70% w/w of Isomelitric Acid.

In certain embodiments, the Melissa officinalis extract used in the present invention may comprise between about 1% w/w, 2%, 3%, 4%, 5%, 6%, 7%, 8%, 9%, 10%, 15%, 20%, 25%, 30%, 35%, 40%, 50%, 60%, 70% w/w of rosmarinic acid to about 60%, 50%, 40%, 30%, 20%, 10%, 5%, 1% w/w of rosmarinic acid

In certain embodiments, the Melissa officinalis extract used in the present invention may comprise between about 1% w/w, 2%, 3%, 4%, 5%, 6%, 7%, 8%, 9%, 10%, 15%, 20%, 25%, 30%, 35%, 40%, 50%, 60%, 70% w/w of Syringic Acid to about 60%, 50%, 40%, 30%, 20%, 10%, 5%, 1% w/w of Syringic Acid.

In certain embodiments, the Melissa officinalis extract used in the present invention may comprise between about 1% w/w, 2%, 3%, 4%, 5%, 6%, 7%, 8%, 9%, 10%, 15%, 20%, 25%, 30%, 35%, 40%, 50%, 60%, 70% w/w of Isomelitric Acid to about 60%, 50%, 40%, 30%, 20%, 10%, 5%, 1% w/w of Isomelitric Acid.

In another embodiment, the effective amount of lemon balm added to the flavored composition provides between about 1 ppm to about 1000 ppm of rosmarinic acid, such as from about 2 ppm, 3 ppm, 5 ppm, 10 ppm, 20 ppm, 30 ppm, 40 ppm, 50 ppm, 60 ppm, 70 ppm, 80 ppm, 90 ppm, 100 ppm, 200 ppm, 300 ppm, 400 ppm, 500 ppm, 600 ppm, 700 ppm, 800 ppm, 900 ppm to 1000 ppm, 900 ppm, 800 ppm, 700 ppm, 600 ppm, 500 ppm, 400 ppm, 300 ppm, 200 ppm, 100 ppm, 90 ppm, 80 ppm, 70 ppm, 60 ppm, 50 ppm, 40 ppm, 30 ppm, 20 ppm, 10 ppm, or to 5 ppm. In certain embodiments, the product comprises from about 50 ppm of rosmarinic acid; preferably 1 ppm to about 50 ppm of rosmarinic acid, preferably about 1 ppm to about 40 ppm rosmarinic acid, more preferably about 1 ppm to about 30 ppm of rosmarinic acid, even more preferably about 10 ppm to about 15 ppm of rosmarinic acid in respect to the final weight of the composition.

In another preferred embodiment, the composition of the invention (such as a beverage), comprises between about 1 ppm to about 1000 ppm of rosmarinic acid, such as from about 2 ppm, 3 ppm, 5 ppm, 10 ppm, 20 ppm, 30 ppm, 40 ppm, 50 ppm, 60 ppm, 70 ppm, 80 ppm, 90 ppm, 100 ppm, 200 ppm, 300 ppm, 400 ppm, 500 ppm, 600 ppm, 700 ppm, 800 ppm, 900 ppm to 1000 ppm, 900 ppm, 800 ppm, 700 ppm, 600 ppm, 500 ppm, 400 ppm, 300 ppm, 200 ppm, 100 ppm, 90 ppm, 80 ppm, 70 ppm, 60 ppm, 50 ppm, 40 ppm, 30 ppm, 20 ppm, 10 ppm, or to 5 ppm. In certain embodiments, the product comprises from about 50 ppm of rosmarinic acid; preferably 1 ppm to about 50 ppm of rosmarinic acid, preferably about 1 ppm to about 40 ppm rosmarinic acid, more preferably about 1 ppm to about 30 ppm of rosmarinic acid, even more preferably about 10 ppm to about 15 ppm of rosmarinic acid in respect to the final weight of the composition.

In another embodiment, the composition of the invention (such as a beverage), comprises between about 1 ppm to about 50 ppm rosmarinic acid, preferably about 1 ppm to about 40 ppm rosmarinic acid, more preferably about 1 ppm to about 30 ppm rosmarinic acid, even more preferably about 3 ppm to about 15 ppm in respect to the final weight of the composition.

In another preferred embodiment, the composition of the invention (such as a beverage), comprises between about 1 ppm to about 1000 ppm of Syringic Acid, such as from about 2 ppm, 3 ppm, 5 ppm, 10 ppm, 20 ppm, 30 ppm, 40 ppm, 50 ppm, 60 ppm, 70 ppm, 80 ppm, 90 ppm, 100 ppm, 200 ppm, 300 ppm, 400 ppm, 500 ppm, 600 ppm, 700 ppm, 800 ppm, 900 ppm to 1000 ppm, 900 ppm, 800 ppm, 700 ppm, 600 ppm, 500 ppm, 400 ppm, 300 ppm, 200 ppm, 100 ppm, 90 ppm, 80 ppm, 70 ppm, 60 ppm, 50 ppm, 40 ppm, 30 ppm, 20 ppm, 10 ppm, or to 5 ppm. In certain embodiments, the product comprises from about 50 ppm of Syringic Acid; preferably 1 ppm to about 50 ppm of Syringic Acid, preferably about 1 ppm to about 40 ppm Syringic Acid, more preferably about 1 ppm to about 30 ppm of Syringic Acid, even more preferably about 10 ppm to about 15 ppm of Syringic Acid in respect to the final weight of the composition.

In another embodiment, the composition of the invention (such as a beverage), comprises between about 1 ppm to about 50 ppm Syringic Acid, preferably about 1 ppm to about 40 ppm Syringic Acid, more preferably about 1 ppm to about 30 ppm Syringic Acid, even more preferably about 3 ppm to about 15 ppm in respect to the final weight of the composition.

In another preferred embodiment, the composition of the invention (such as a beverage), comprises between about 1 ppm to about 1000 ppm of Isomelitric Acid, such as from about 2 ppm, 3 ppm, 5 ppm, 10 ppm, 20 ppm, 30 ppm, 40 ppm, 50 ppm, 60 ppm, 70 ppm, 80 ppm, 90 ppm, 100 ppm, 200 ppm, 300 ppm, 400 ppm, 500 ppm, 600 ppm, 700 ppm, 800 ppm, 900 ppm to 1000 ppm, 900 ppm, 800 ppm, 700 ppm, 600 ppm, 500 ppm, 400 ppm, 300 ppm, 200 ppm, 100 ppm, 90 ppm, 80 ppm, 70 ppm, 60 ppm, 50 ppm, 40 ppm, 30 ppm, 20 ppm, 10 ppm, or to 5 ppm. In certain embodiments, the product comprises from about 50 ppm of Isomelitric Acid; preferably 1 ppm to about 50 ppm of Isomelitric Acid, preferably about 1 ppm to about 40 ppm Isomelitric Acid, more preferably about 1 ppm to about 30 ppm of Isomelitric Acid, even more preferably about 10 ppm to about 15 ppm of Isomelitric Acid in respect to the final weight of the composition.

In another embodiment, the composition of the invention (such as a beverage), comprises between about 1 ppm to about 50 ppm Isomelitric Acid, preferably about 1 ppm to about 40 ppm Isomelitric Acid, more preferably about 1 ppm to about 30 ppm Isomelitric Acid, even more preferably about 3 ppm to about 15 ppm in respect to the final weight of the composition.

In certain embodiments, the composition is a liquid or semi-liquid composition including, but not limited to fruit and vegetable juice, broth, soft drinks (carbonated or noncarbonated), sports drinks, electrolyte-replacement drinks, coffee, tea, milk or dairy-free milk alternatives, milkshakes, malts, smoothies, clear or creamed soups, yogurts, creams, ice-creams, etc.

In certain embodiments, the flavor comprises citral or a citral-derivative.

In certain embodiments, the flavor is a synthetic flavor and/or a natural flavor.

In certain embodiments, the flavor is a citrus flavor selected from one or more of lemon, orange, lime and grapefruit, as well as many more hybrids and varieties know by the person skilled in the art.

In certain embodiments, the flavor is a natural citrus flavor selected from one or more of lemon, orange, lime and grapefruit, as well as many more hybrids and varieties know by the person skilled in the art.

In certain embodiments, the flavor is a synthetic citrus flavor selected from one or more of lemon, orange, lime and grapefruit, as well as many more hybrids and varieties know by the person skilled in the art.

In certain embodiments, the flavor is a natural citrus flavor comprising citral or a citral-derivative selected from one or more of lemon, orange, lime and grapefruit, as well as many more hybrids and varieties know by the person skilled in the art.

In certain embodiments, the flavor is a synthetic citrus flavor comprising citral or a citral-derivative selected from one or more of lemon, orange, lime and grapefruit, as well as many more hybrids and varieties know by the person skilled in the art. In certain embodiments, the compositions (such as a beverage) has a preserved intensity of citrus flavor, a preserved freshness of the citrus flavor and/or a preserved candy notes of the citrus flavor in the citrus-flavored composition.

Methods of measurement of the Sensory profiling are known in the art, such as the ones described in the examples of the present application.

Without being bound to any theory, the off notes developed in the product when no lemon balm extract is used (i.e. loss of freshness, oxidized citral taste, oxidized terpenes taste, etc.) may be arising from the oxidation of one or more components present in the flavor used in the composition, such as oxidation of citral or oxidation or citral derivates.

From the experiments included in the present text, it is clear that the use of lemon balm extract impairs the development of those undesirable off notes while the typical taste of the flavor (in this case citrus flavors) are preserved, even at very long storage times (more than 6, 9 or even 12 weeks) at high temperatures (see example 4).

As used herein, the term “oxidation” refers to the exposure of the composition and/or foodstuff to conditions (such as for example an amount of atmospheric oxygen) that is sufficient enough to significantly oxidize it. The oxidation will occur via reactions including but not limited to reactions promoted by oxygen or induced by the presence of metal, such as iron (reaction of Fenton), as it may produce undesirable off notes that affects the quality and sensorial experience of the consumers. As used herein, the expression “preventing and/or inhibiting oxidation of a composition” refers to the reduction of the oxidation which occurs to the foodstuff in the presence of the composition of the invention in comparison to the oxidation which occurs in the absence of said composition. The term “prevention” refers to the complete absence of oxidation in the foodstuff when the foodstuff comprises the composition of the invention. The term “inhibiting” refers to the reduction of the level of oxidation which occurs to the foodstuff when in the presence of oxygen. In a particular embodiment of the process of the invention the oxidation of the foodstuff is inhibited by at least 1%, at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, in comparison with the level of oxidation of the foodstuff without the composition of the invention. Methods for measuring the food oxidation are well known in the art and in the literature, e.g., Barriuso et al, 2013 (European Food Research and Technology volume 236, pages 1-15).

In certain embodiments of the methods of the invention, the flavored composition, such as a beverage, specially a citrus flavored beverage, is stored at a temperature of more than about 20° C., such as a more than about 30° C., such as more than about 35° C.

In certain preferred embodiments, the temperature of storage is more than about 38° C.

In certain preferred embodiments, the flavored composition is stored in dark conditions.

In certain embodiments of the methods of the invention, the flavored composition, such as a beverage, specially a citrus flavored beverage, is stored for more than about 4 weeks, such as more than about 5 weeks, more than about 6 weeks, more than about 7 weeks, more than about 8, 9, 10, 11, 12 weeks or at more than about 13 weeks.

In certain embodiments of the methods of the invention, the flavored composition, such as a beverage, specially a citrus flavored beverage, has no color change or no color change is observed during or at the end of storage time; or the color change is less than about 5% in respect of the color before storage. Methods for measuring color change are known in the art, such as Lab measurement.

In certain embodiments the composition has a preserved intensity of the flavor, a preserved freshness of the flavor and/or a preserved candy notes of the flavor in the composition.

The invention is related to a composition obtained according to the methods of the present invention as defined herein. All previous embodiments and definitions described in relation with the previous aspects (methods) are equally valid for the current aspect and its embodiments (compositions of the invention).

The composition may be a food product, such as a liquid or a semi-liquid food product.

In a preferred embodiment the foodstuff of the invention is a beverage. The term “beverage” as used herein refers to any potable or edible liquid. In another preferred embodiment of the foodstuff, the beverage is a lemon flavoured beverage, being the flavour natural and/or artificial.

The composition may be a nutraceutical product, such as a liquid or a semi-liquid nutraceutical product. The term “nutraceutical” as used herein refers to substances useful in both nutritional and pharmaceutical fields of application.

In certain embodiments the composition has a preserved intensity of the flavor, a preserved freshness of the flavor and/or a preserved candy notes of the flavor in the composition.

The invention will be described by way of the following examples which are to be considered as merely illustrative and not limitative of the scope of the invention.

### EXAMPLES

### Example 1: Product Description—Lemon Balm Extract

Lemon Balm (LB) leaves were extracted using 10% activated carbon with an alcoholic solvent composed from 70% ethanol and 30% water at 50° C. for 2 hours under mechanical stirring. After the extraction was completed, the ethanol extract was filtered to remove the plant residues. The resulting ethanolic extract was concentrated under reduced pressure until 5% of dry matter. Then, one volume of water was added to precipitate water insolubles. The insolubles were filtrated and the resulting water soluble extract was concentrated with propylen glycol under reduced pressure. The final product composition was 60% propylen glycol, 30% Lemon Balm extract and 10% water. Rosmarinic Acid (RA) described in the Formula 1 was present in the extract at 4-5%.

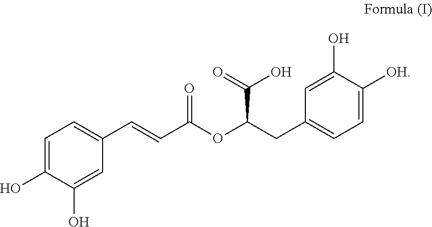 [SMILES: O=C(/C=C/c1ccc(O)c(O)c1)O[C@H](Cc1ccc(O)c(O)c1)C(=O)O]

### Example 2: Methods

Analysis of the extract composition by HPLC-MS and quantification by HPLC-DAD.

The sample was analyzed by LC-ESI-QTOF and then HPLC-DAD. All compounds were quantified as rosmarinic acid.

### HPLC and HPLC-MS Analytical Conditions:

Column: Zorbax Eclipse Plus C18 250×4.6 mm 5 μm-Agilent
Column temperature: 30° C.
Flow rate: 1 mL/min (split after DAD for LC-MS)
Detection at 280 nm, 350 nm and Q-TOF
Injection volume: 5 μL

### Mobile Phase:

A: 0.1% formic acid in water
B: 0.1% formic acid in acetonitrile

| Time | | |
|---|---|---|
| (min) | % A | % B |
| 0 | 10 | 90 |
| 25 | 40 | 60 |
| 27 | 0 | 100 |
| 37 | 0 | 100 |

TABLE 1
Possible identification of LB extract composition by HPLC-MS

| | Tr | | | | | |
|---|---|---|---|---|---|---|
| | (min, | | Possible | | | |
| Peak | TIC) | Formula | identification | m/z | Adducts | |
| 1′ | 2.40 | C12H22O11 | Disaccharide | 341.1091 | [M − H]−, [M + HCOO]− | |
| 2′ | 2.43 | C12H12O7 | Gluconic acid | 195.0512 | [M − H]−, [M + HCOO]−, | |
| 3′ | 2.47 | C5H10O6 | Xylonic acid | 165.0405 | [M − H]−, [M + HCOO]−, | |
| | | | | | [M + CH3COO]− | |
| 4′ | 2.51 | C7H12O6 | Quinic acid | 191.0563 | [M − H]−, [M + HCOO]−, | |
| | | | | | [M + CH3COO]− | |
| 5′ | 2.66 | C7H10O5 | Shikimic acid | 173.0456 | [M − H]−, [M + HCOO]−, | |
| | | | | | [M + CH3COO]− | |
| 6′ | 2.74 | C4H6O5 | Malic acid | 133.0145 | [M − H]−, [M + HCOO] | |
| 7′ | 2.95 | C6H8O7 | Citric or isocitric acid | 191.0199 | [M − H]− | |
| 8′ | 3.37 | C6H8O7 | Citric or isocitric acid | 191.0199 | [M − H]− | |
| 9′ | 4.87 | C8H10O3 | Syringol | 153.0559 | [M − H]−, [M + HCOO] | |
| 10′ | 5.02 | C18H20O10 | Caffeic acid derivative | 395.0984 | [M − H]− | 72.9931, |
| | | | | | | 135.0451, |
| | | | | | | 179.0350, |
| | | | | | | 197.0455 |
| 11′ | 5.03 | C9H10O5 | Syringic acid | 197.0460 | [M − H]− | 123.0452, |
| | | | | | | 135.0451 |
| 12′ | 6.22 | C7H6O4 | Protocatechuic acid | 153.0194 | [M − H]− | |
| 13′ | 6.46 | C13H12O9 | Caffeoyl tartaric acid | 311.0408 | [M − H]− | 135.0452 |
| 14′ | 6.47 | C9H8O4 | Caffeic acid | 179.0348 | [M − H]− | 135.0453 |
| 15′ | 6.57 | C15H18O9 | Caffeoyl glucose | 341.0880 | [M − H]− | 135.0453 |
| 16′ | 8.49 | C7H6O3 | 3,4- | 137.0245 | [M − H]−, | 92.0267, |
| | | | Dihydroxybenzaldehyde | | [M + HCOO] | 108.0217, |
| | | | | | | 119.0135 |
| 17′ | 10.08 | C27H24O14 | yunnaneic acid | 571.1093 | [M − H]−, | 197.0458 |
| | | | Derivative | | [M + HCOO] | |
| 18′ | 11.63 | C18H14O8 | Chlorogenic acid | 357.0615 | [M − H]− | |
| | | | derivative | | | |
| 19′ | 11.69 | C27H22O12 | Lithospermic acid A | 537.1035 | [M − H]− | 295.0612 |
| 20′ | 12.67 | C27H24O12 | yunnaneic acid | 539.1192 | [M − H]−, | 135.0452, |
| | | | Derivative | | [M + HCOO] | 161.0243, |
| | | | | | | 197.0458 |
| 21′ | 13.17 | C27H24O12 | yunnaneic acid | 539.1192 | [M − H]−, | 135.0457, |
| | | | Derivative | | [M + HCOO] | 197.0463 |
| 22′ | 13.63 | C22H18O12 | Chicoric acid | 473.0724 | [M − H]−, | 149.0611 |
| | | | | | [M + HCOO]−, | |
| | | | | | [M + CH3COO]− | |
| 23′ | 13.84 | C24H26O13 | Rosmarinic acid | 521.1308 | [M − H]−, | 161.0247, |
| | | | hexoside | | [M + HCOO] | 197.0457, |
| | | | | | | 323.0773 |
| 24′ | 15.38 | C36H32O16 | Sagerinic acid/ | 719.1619 | [M − H]−, | 161.0249, |
| | | | caffeic acid tetramer | | [M + HCOO] | 197.0456, |
| | | | | | | 359.0770, |
| | | | | | | 539.1192 |
| 25′ | 16.72 | C36H32O16 | Sagerinic acid/ | 719.1619 | [M − H]−, | 161.0247, |
| | | | caffeic acid tetramer | | [M + HCOO] | 197.0456, |
| | | | | | | 359.0772 |
| 26′ | 16.98 | C21H18O12 | Luteolin-7- | 461.0725 | [M − H]−, | 285.0407 |
| | | | glucuronide | | [M + Cl]−, | |
| 27′ | 17.19 | C18H16O16 | Rosmarinic acid | 359.0778 | [M − H]−, | 123.0452, |
| | | | | | [M + Cl]−, | 161.0246, |
| | | | | | [M + HCOO] | 179.0351, |
| | | | | | | 197.0455 |
| 28′ | 18.54 | C27H22O12 | Isomelitric acid/ | 537.1038 | [M − H]−, | 135.0450, |
| | | | Melitricacid A | | [M + HCOO] | 161.0242, |
| | | | | | | 197.0460, |
| | | | | | | 295.0608 |
| 29′ | 19.68 | C27H22O12 | Isomelitric acid/ | 537.1038 | [M − H]−, | 135.0453, |
| | | | Melitricacid A | | [M + HCOO] | 161.0246, |
| | | | | | | 197.0457, |
| | | | | | | 295.0614 |
| 30′ | 20.66 | C36H30O16 | Salvianolic acid B | 717.1458 | [M − H]−, | 339.0512, |
| | | | | | [M + Cl]−, | 519.0928 |
| | | | | | [M + HCOO] | |
| 31′ | 22.74 | C27H20O12 | pulmitric acid B/ | 535.0886 | [M − H]− | 177.0197, |
| | | | sagecoumarin | | | 491.1011 |
| 32′ | 28.03 | C44H34O18 | Trihydroxycinnamic | 949.1666 | [M − H]−, | 359.0773, |
| | | | acid derivative | | [M + HCOO] | 687.1357 |

A total of 32 compounds were identified by HPLC-MS (Table 1), principally phenolic compounds with an antioxidative activity. Major compounds were Rosmarinic Acid, Isomelitric Acid and Syringic Acid.

TABLE 2

| Compound name | Content (%) |
|---|---|
| Syringic Acid | 0.18% |
| Rosmarinic Acid | 4.32% |
| Isomelitric Acid | 1.03% |

### Example 3: In Vitro Test ORAC

Determination of the antioxidant capability by Oxygen Radical Absorbance Capacity was conducted on a fluorescence micro plate reader Tecan Infinite, following the procedure of Ou et al. 2013 (AOAC Official Method 2012.23 Total Antioxidant Activity). The method describes how to carry out the analysis for lipophilic and hydrophilic sample.

ORAC-Assay measures the capacity of a sample to bind oxygen radicals. Reactive oxygen species generators (AAPH) are added in parallel reactions that contain equal amounts of a fluorescent probe (Fluorescein sodium salt). Reactions contain either a buffer blank or antioxidant samples and standard (Trolox). The antioxidant capacity of a sample is the net difference between the area under the curve (AUC) of the sample and that of the blank. This net AUC of sample is compared to the net AUC of Trolox standard concentration in order to have the ORAC value of the sample expressed as μmol Trolox equivalent per gram (μmol TE/g).

### In Vitro Test CAT

Determination of the antioxidant capability by Conjugated Autoxidizable Triene was conducted on a micro plate reader Tecan Infinite, following the procedure of Laguerre et al. Analytical Biochemistry 380 (2008) 282-290.

As ORAC-Assay, CAT-Assay measures the capacity of a sample to bind oxygen radicals. Reactive oxygen species generators (AAPH) are added in parallel reactions that contain equal amounts of an absorbance probe (emulsion). Reactions contain either a buffer blank or antioxidant samples and standard (Trolox). The antioxidant capacity of a sample is the net difference between the area under the curve (AUC) of the sample and that of the blank. This net AUC of sample is compared to the net AUC of Trolox standard concentration in order to have the CAT value of the sample expressed as μmol Trolox equivalent per gram (μmol TE/g).

TABLE 3
In vitro ORAC and CAT results for Lemon Balm
extract in comparison to a standard of RA

| | ORAC/% RA | CAT/% RA |
|---|---|---|
| Sample analyzed | (μmol TE/g) | (μmol TE/g) |
| Lemon Balm extract | 497 | 233 |
| Rosmarinic Acid | 243 | 87 |
| Standard 98% | | |

As we can see in the table 3, if we compare ORAC and CAT results for 1% of RA, Lemon Balm was much more active than pure RA. This difference could be due to the presence of other compounds in the Lemon Balm extract with an antioxidative activity, as isomelitric acid, syringic acid and other phenolic acids.

### Example 4: Technical Tasting in Beverages for Natural Lemon and Orange Flavor Protection

Lemon or Orange flavour was added in a standard beverage matrix (acidified and sugar water), with or without Lemon Balm extract (112 ppm for Lemon flavour or 337 ppm for Orange flavour, 3 ppm rosmarinic acid in end application). Then “aged” samples were subjected to a 6 or 12 weeks accelerated aging process at 38.5° C. and “fresh” samples were stored at 4° C. A triangle technical tasting was then conducted. For each set, 10-12 technical tasters were presented with three blind samples. The tasters were asked to determine which sample is the different sample.

TABLE 4
Protection of natural Lemon flavor in
beverages during aging at 38.5° C.

| Sample | 1 week | 2 weeks | 4 weeks | 6 weeks |
|---|---|---|---|---|
| Control | Stable | Not Stable | — | — |
| With LB | Stable | Stable | Stable | Not Stable |
| extract | | | | |
| (112 ppm) | | | | |

As we can see in the Table 4, the Control is unstable at 2 weeks aging. However, sample with the Lemon Balm extract is stable during more than 4 weeks. These results showed the important antioxidative activity of Lemon Balm extract in beverages to protect natural Lemon flavor.

TABLE 5
Protection of natural Orange flavor
in beverages during aging at 38.5° C.

| Sample | 3 weeks | 6 weeks | 9 weeks | 12 weeks |
|---|---|---|---|---|
| Control | Stable | Stable | Not | — |
| | | | Stable | |
| With LB | Stable | Stable | Stable | Stable |
| extract | | | | |
| (337 ppm) | | | | |

As we can see in the Table 5, the Control is unstable at 9 weeks aging. However, sample with the Lemon Balm extract is stable during more than 12 weeks. These results showed the important antioxidative activity of Lemon Balm extract in beverages to protect natural Orange flavor.

### Example 5: Sensory Profiling in Beverages for Natural Lemon Flavor Protection

Lemon flavour+12 ppm of Citral was added in a standard beverage matrix (acidified and sugar water), with or without Lemon Balm extract (68 ppm). Then “aged” samples were subjected to a 4 weeks accelerated aging process at 40° C. and “fresh” samples were stored at 4° C.

Sensory profiling was conducted on “fresh” and “aged” samples with and without antioxidants to understand how well the solutions work. Flavor Impression profiling consists of quantifying the sensory characteristics of products through open group discussion. Specialists trained panelists taste the full product set and generate descriptors specifically for the samples to be assessed. They rate intensity scores for each of these descriptors individually, then discuss as a group what each has rated, and agree on a final consensus profiling. The test is run in a discussion room, and results are collected by the panel leader.

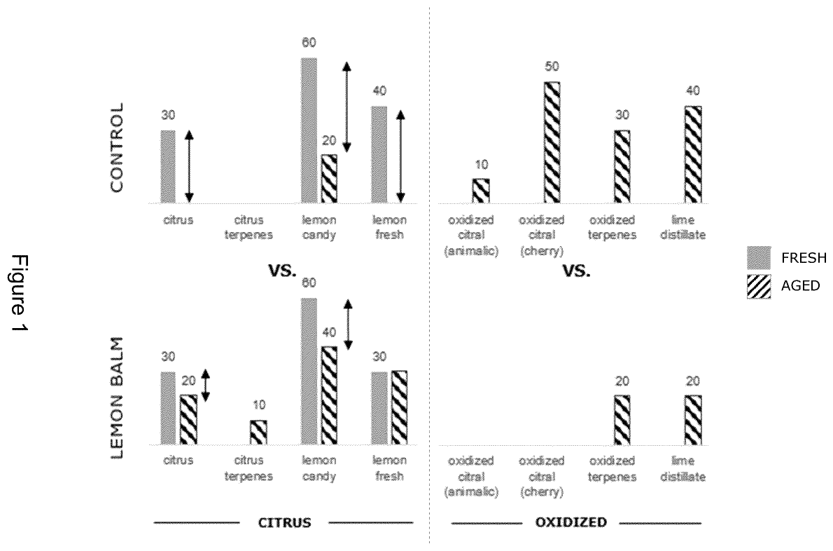

As we can see in the FIG. 1, Lemon profile was better retained in aged Lemon Balm sample vs aged Control. There was less decrease in citrus and lemon candy notes. Lemon fresh note was maintained.

There was overall less oxidized character in aged Lemon Balm sample vs aged control. No oxidized citral note was perceived and there was less oxidized terpenes and lime distillate notes.

These results showed the Lemon flavor protection of the Lemon Balm extract and confirmed the results of the technical tasting.

### Example 6: Extended Technical Tasting in Beverages for Natural Lemon Flavor Protection

A citrus-flavored beverage was tested for protection of the citrus flavor. The beverage, (9° Brix/pH=3.5) was prepared by mixing the food-grade components listed in table 6 and the pH adjusted. Then the beverage preparation was pasteurized at 85° C. for 20 seconds and filled in clean 500 mL PET bottle under aseptic conditions. The beverage contained 100 ppm lemon balm extract. The filled bottle was put in dark conditions to evaluate the stability. After 6 months, the beverage was tested for the following descriptors: overall citrus intensity; sweet; bitter; acidic/sour; peely; oxidized orange; cardboard/stale and lingering after taste.

TABLE 6

| Ingredient | % (g) |
|---|---|
| Sugar extra fine | 9.000 |
| Potassium sorbate (granular) | 0.025 |
| Sodium benzoate (granular) | 0.015 |
| Citric acid, anhydrous | 0.162 |
| Sodium citrate dihydrate (granular) | 0.020 |
| Water | 90.668 |
| Citrus flavor | 0.100 |
| Lemon balm extract | 0.010 |

Even after 6 months, the technical tasting result was categorized as “stable” i.e. the tested samples were difficult to distinguish compared to a control sample (without lemon balm extract; at 0 month), in that no samples dominated for a specific descriptor.

1. A method for preparing a storage-stable flavored composition, said method comprising:
(a) providing a flavored composition comprising a synthetic and/or natural flavor as a flavoring agent; and
(b) adding a lemon balm extract comprising rosmarinic acid to the flavored composition from step (a) to obtain the storage-stable flavored composition.

2. A method for increasing the shelf life, reducing oxidation and/or reducing off notes of a flavored composition during storage, said method comprising:
(a) providing a citrus-flavored composition comprising a synthetic and/or natural flavor as a flavoring agent; and
(b) adding a lemon balm extract comprising rosmarinic acid to the flavored composition from step (a).

3. The method of claim 1, wherein the composition is a liquid or semi-liquid composition.

4. The method of claim 1, wherein the flavor comprises citral or a citral-derivative.

5. The method of claim 1, wherein the flavor is a citrus flavor selected from one or more of lemon, orange, lime and grapefruit.

6. The method of claim 1, wherein the composition has a preserved intensity of the flavor, a preserved freshness of the flavor and/or a preserved candy notes of the flavor in the composition.

7. The method of claim 6, wherein the composition has a preserved intensity of citrus flavor, a preserved freshness of the citrus flavor and/or a preserved candy notes of the citrus flavor in the citrus-flavored composition.

8. The method of claim 1, wherein the flavored composition is stored at a temperature of more than about 20° C.

9. The method of claim 1, wherein the temperature of storage is more than about 38° C.

10. The method of claim 1, wherein the flavored composition is stored in dark conditions.

11. The method of claim 1, wherein storage time is of more than about 4 weeks.

12. The method of claim 1, wherein the effective amount of lemon balm added to the flavored composition provides about 3 ppm weight percent and greater of rosmarinic acid, based on the total weight of the composition.

13. The method of claim 1, wherein no color change is observed during or at the end of storage time or the color change is less than about 5% in respect of the color before storage.

14. The method of claim 1, wherein the lemon balm extract is an extract obtained using one or more of the following solvents: water, alcoholic solvent.

15. The method of claim 1, wherein the lemon balm extract comprises rosmarinic acid and one or more of: Isomelitric Acid, Syringic Acid, Caffeoyl tartaric acid, Caffeic acid, yunnaneic acid derivative, Sagerinic acid/caffeic acid tetramer, Luteolin-7-glucuronide, Salvianolic acid B, pulmitric acid B/sagecoumarin, Trihydroxycinnamic acid derivative.

16. The method of claim 1, wherein the lemon balm extract is obtained from aerial parts.

17. The method of claim 1, wherein the composition is selected from beverages.

18. A composition obtained according to the method of claim 1.

19. The method of claim 1, wherein the composition is a liquid.

20. The method of claim 2, wherein the composition is a liquid or semi-liquid composition.
